(19) United States
(12) Patent Application Publication
(10) Pub. No.: US 2022/0211087 A1
(43) Pub. Date: Jul. 7, 2022

(54) FERMENTED CEREAL

(71) Applicant: SOCIETE DES PRODUITS NESTLE S.A., Vevey (CH)

(72) Inventors: Jeroen Andre Muller, Epalinges (CH); Edwin Ananta, Singapore (SG); Lijuan Ye, Lausanne (CH); Ann Limley, Orbe (CH)

(21) Appl. No.: 17/595,258

(22) PCT Filed: May 15, 2020
(86) PCT No.: PCT/EP2020/063658

§ 371 Date: Nov. 12, 2021

(30) Foreign Application Priority Data
May 17, 2019 (EP) 19175193.2

(51) Int. Cl. A23L 25/00; A23L 7/104; A23L 7/135; A23L 7/126

(52) U.S. Cl. CPC A23L 25/40; A23L 7/126; A23L 7/135; A23L 7/104

(57) ABSTRACT

The present invention relates to a cereal product comprising a fermented slurry of rice flour made from koji rice (fermented rice). The fermented rice flour provides a natural and mild sweetness and glue for binding but is not too sticky during coating. The use of the slurry allows for a reduction/removal of added (refined) sugar in the final product because the fermented cereal slurry brings natural sweetness.

### TECHNICAL FIELD OF THE INVENTION

The present invention relates to a cereal product comprising a fermented slurry of rice flour made from koji rice (fermented rice). The fermented rice flour provides a natural and mild sweetness and glue for binding but is not too sticky during coating. The use of the slurry allows for a reduction/removal of added (refined) sugar in the final product because the fermented cereal slurry brings natural sweetness.

### BACKGROUND OF THE INVENTION

There is a continued wish to try to reduce as much as possible of consumer's daily diet in terms of refined sugars as well as to bring non-refined sources of sweetness. As sugars remain necessary for organoleptic purposes, such as sweetness and texture, substituting refined sugars (or high intensive sweeteners) by some natural equivalent food material is not an easy task. Such replacement food materials must prove to be stable and compatible with the other co-ingredients, as well as it must keep an acceptable taste in the concerned foodstuffs.

Hence, an improved naturally sweetened food coating/binding system would be advantageous, and in particular, a naturally sweetened food coating having organoleptic properties comparable to other coatings or binders made with refined sugars would be advantageous.

### SUMMARY OF THE INVENTION

The present invention relates to a cereal product comprising a fermented slurry of rice flour made from koji rice (fermented rice that has been inoculated with Aspergillus oryzae). The fermented rice flour provides a natural and mild sweetness and glue for binding but is not too sticky during coating. The use of the slurry allows for a reduction/removal of added (refined) sugar in the final product because the fermented cereal slurry brings natural sweetness. As also outlined in example 5 the fermented rice flour is superior (compared to other fermented flours) in relation to organoleptic parameters such as sweetness, bitterness, and in functioning as a binder/clustering agent, e.g. for the preparation of granola.

Thus, an object of the present invention relates to the provision of an alternative binder/clustering agent for the preparation of e.g. granolas.

It is also an object to provide a binder/clustering agent, which has the sufficient adhesive properties without being too sticky. The adhesive properties are important to get the right clustering and/or to ensure integrity of bars during transport and shelf life, while avoiding fouling of equipment during granolas, bars and cereal processing.

In particular, it is an object of the present invention also to provide an alternative binder/clustering agent that solves the above mentioned problems of the prior art with high refined sugar content and/or high content of high intensive sweeteners.

In a general aspect, which is to be considered combinable with the other aspects of the invention (without specification to a specific type of flour), the invention relates to a cereal product, comprising fermented flour. Preferably, the flour is fermented by koji rice.

A further aspect of the invention relates to a cereal product, comprising fermented rice flour. Preferably, the rice flour is fermented by koji rice. As also outlined in example 5 the rice flour fermented with koji rice is superior in relation to organoleptic parameters such as sweetness, bitterness, and in functioning as a binder/clustering agent, e.g. for the preparation of granolas.

Another aspect of the present invention relates to a food ingredient comprising the cereal product according to the present invention.

Yet another aspect of the present invention is to provide a food product comprising the food ingredient according to the invention.

Still another aspect of the present invention relates to the use of a fermented slurry of rice flour as a sweetener for food/feed and/or the use of a fermented slurry of rice flour as a clustering agent (binder) for canola production.

Yet a further aspect relates to a process for preparing a cereal product, the process comprising:
providing a cereal product;
providing a fermented slurry of rice flour, preferably, the rice flour is fermented by koji rice;
applying the fermented slurry of rice flour to the cereal product;
optionally, baking the cereal product comprising the fermented slurry of rice flour; and
optionally drying the cereal product comprising the fermented slurry of rice flour.

Also the invention relates to a cereal product obtained by a process according to the invention.

### BRIEF DESCRIPTION OF THE FIGURES

FIG. 1 shows a process for preparing a concentrated fermented cereal slurry made from rice koji (Amazake).

FIG. 2 shows a process for preparing granolas made with the concentrated fermented cereal slurry made from rice koji (Amazake).

FIG. 3 shows a process for preparing “ready to eat” cereals coated with the concentrated fermented cereal slurry made from rice koji (Amazake).

FIG. 4 shows a process for preparing muesli coated with the concentrated fermented cereal slurry made from rice koji (Amazake).

The present invention will now be described in more detail in the following.

### DETAILED DESCRIPTION OF THE INVENTION

### Definitions

Prior to discussing the present invention in further details, the following terms and conventions will first be defined:

Granola

In the present context, the term “granola” refers to a breakfast food and snack food. It may comprise rolled oats (or other grains), and e.g. nuts, honey or other sweeteners such as brown sugar, and sometimes puffed rice, that is usually baked until it is crisp, toasted and golden brown.

Granola generally designates a food made of baked grains, nuts, dried fruit, and cereals, and/or other edible pieces or particulates bound together by a “binder”. While similar unbound mixes usually called trail mixes or muesli are known, the present invention relates to mixes bound together and the meaning of “granola” according to the present invention is limited to such bound mixes. In the present context, a granola may also be a granola bar.

Muesli/Müesli

In the present context “Muesli” or “Müesli” or “Müsli” refers to a cereal based on rolled oats and ingredients like grains, nuts, seeds and fresh or dried fruits. Mueslis are normally not baked.

Koji Fermentation

The term “Koji fermentation” refers to a fermentation process, for example a solid state fermentation process, of soybean, wheat, barley and/or rice with a mould such as an Aspergillus for the production of various traditional food and beverage products, for example miso, soy sauce, sake, and the like.

Fermentation with Aspergillus oryzae has the advantage that Aspergillus oryzae is a well recognized filamentous fungus used in traditional Koji fermentations. It is absolutely safe for food consumption and provides typical flavour notes such as soy sauce.

Koji Rice

Koji rice is (cooked) rice that has been inoculated with Aspergillus, preferably Aspergillus oryzae. The mold releases enzymes that ferments the rice by decomposing its carbohydrates and proteins. This process may also be applied to other grains like barley, and legumes like soybeans. Thus, Koji rice is fermented rice.

Refined Sugar

Sugar is defined as a source of mono and disaccharides (examples are: saccharose, glucose, fructose, lactose). Refined sugar is a source of mono and disaccharides that has been through a refining step, usually a chemical step, in order to remove impurities and other nutrients. “Refined sugar” may also be named “white sugar”.

High Intensity Sweetener

High-intensity sweeteners are commonly used as sugar substitutes or sugar alternatives because they are many times sweeter than sugar but contribute only a few to no calories when added to foods. Examples of such sweeteners are aspartame, sucralose, and stevia.

Cereal Product, Comprising Fermented Rice Flour Made from Koji Rice

As also outlined in the example section, in here is disclosed a cereal product comprising rice flour fermented by koji rice. It has been found that fermentation of rice flour with koji rice, has superior properties compared to fermentation of other flours with koji rice (see example 5). Thus, an aspect of the invention relates to a cereal product, comprising fermented rice flour and/or fermented milled rice. In a preferred embodiment, the rice flour and/or milled rice have been fermented by koji rice. Koji rice is (cooked) rice that has been inoculated with Aspergillus, preferably Aspergillus oryzae (see also example 1).

In an embodiment, the fermented rice is milled rice. In a preferred embodiment, the milled rice has an (average) particle size below 1.5 mm. In another preferred embodiment, the milled rice has the particle size of flour. Thus, in yet an embodiment the fermented rice is rice flour.

In an embodiment, the fermented rice flour is in the form of a coating on the cereals or in the form of a clustering agent (binder), such as for clustering of granola or cereal bars. In examples 2-4, processes a disclosed for producing such products. In the present context, the terms “clustering agent”, “binder” or “binding agent” have been used interchangeably.

Different types of cereals may find use in the product of the invention. Thus, in an embodiment, the cereals are extruded cereals, puffed cereals, and/or rolled grains).

Different types of rice flour (or milled rice) may be used. Thus in an embodiment the rice flour is selected from the group consisting of polished rice and brown rice, preferably polished rice. These are considered more neutral in taste. In another embodiment, the flour is refined flour and/or whole grain flour.

For certain uses, it could be foreseen that blends of fermented grains/flours would be useful instead of fermenting rice only. Thus, in an embodiment, the fermented flour comprises 50-100% (w/w) fermented rice and 0-50% (w/w) of other flours selected from wheat, rye, barley, oats and combinations thereof, such as 50-90% fermented rice and 10-50% (w/w) of other flours, or such as 50-80% fermented rice and 20-50% (w/w) of other flours.

As outlined in example 5, the fermented (polished) rice provides superior organoleptic properties compared to the other tested flours. Thus, in an embodiment, the cereal product comprises less than 0.01% (w/w) of high intensive sweeteners, such as stevia, preferably the cereal product is free of high intensive sweeteners, such as stevia. In another embodiment, the cereal product comprises less than 10% (w/w) refined sugar, such as less than 5% such as less than 2%, such as less than 1%, preferably such as less than 0.1%, and even more preferably free of refined sugar. The fermented rice flour provides a natural and mild sweetness and glue for binding, but is not too sticky during coating. The use of the slurry allows for a reduction/removal of added (refined) sugar and high intensive sweeteners in the final product, because the fermented cereal slurry brings natural sweetness.

Different types of cereal products could be used together with the present invention. Thus in an embodiment, the cereal product is selected from the group consisting of granolas, such as granolas clusters and granola bars, cereal bars and mueslis.

Different further ingredients could be added to the cereal product (such as a muesli or granola to improve the taste experience). Thus, in another embodiment, the cereal product further comprises flake grains e.g. oat, dry fruit pieces, nuts, seeds, and/or cocoa powder. In a further embodiment, cereal product comprises oat, preferably rolled oats. In yet an embodiment, the cereal product comprises more than 40% by weight of cereal flakes. In yet another embodiment, the cereal flakes comprise a majority of oat flakes or consists of oat flakes.

The amount of the fermented rice flour may vary in the cereal product. Thus, in an embodiment, the fermented rice flour constitutes in the range 5-50% by weight of the cereal product, such as in the range 10-40% by weight. For granolas higher amounts are normally used, such as in the range 20-50% by weight, whereas lower amount would normally be used in muesli's, such as in the range 5-20% by weight.

Food Ingredient

The cereal product according to the invention could also be a food ingredient. Thus, another aspect of the invention relates to a food ingredient comprising the cereal product according to the invention. In an embodiment, the ingredient is a topping and/or sweet snack.

Food Product

The food ingredient according to the invention should naturally also be used in a food product. Thus, a further aspect of the invention, relates to a food product comprising the food ingredient according to the invention. In an embodiment, the food product is selected from the group consisting of naturally sweeten rice beverage, beverages, ice creams, yoghurts confectionaries, toppings, savoury and/or sweet snacks (clusters of granolas), biscuits, doughs and cakes.

Uses

The fermented slurry according to the invention may have different relevant uses. Thus, an aspect of the invention relates to the use of a fermented slurry of rice flour as a sweetener for food and/or feed, such as pet food. In an embodiment, said food/feed is a cereal product such as granola product or muesli product. Preferably, the fermented slurry of rice is fermented with koji rice.

Yet an aspect of the invention, relates to the use of a fermented slurry of rice flour as a clustering agent (binder) for granola production. Preferably, the fermented slurry of rice is fermented with koji rice.

In an embodiment, the slurry of rice flour fermented with koji rice has a total solid content in the range 30-70%, such as in the range 50-70%. If the solid content is to low, the product will be too wet leading to drying issues and making the product texture very soft, whereas if too high it will not cover and bind properly to the cereal.

Process for Preparing a Cereal Product

The present invention also relates to a process for preparing a cereal product. Thus, as aspect relates to a process for preparing a cereal product, the process comprising:
providing a cereal product;
providing a fermented slurry of rice flour;
applying the fermented slurry of rice flour to the cereal product;
optionally, baking the cereal product comprising the fermented slurry of rice flour; and
optionally drying the cereal product comprising the fermented slurry of rice flour.

Another more specific aspect relates to a process for preparing a cereal product, the process comprising:
providing a cereal product;
providing a fermented slurry of rice flour, wherein the fermented rice flour has been fermented by koji rice;
applying the fermented slurry of rice flour to the cereal product;
optionally, baking the cereal product comprising the fermented slurry of rice flour; and
optionally drying the cereal product comprising the fermented slurry of rice flour.

In an embodiment, the slurry of rice flour fermented by koji rice is applied to the cereal product as a coating or as clustering agent (binder), such as for clustering the cereal product into granola.

In an embodiment, the slurry of rice flour fermented by koji rice has a total solid content in the range 30-70%, such as in the range 50-70%. Again, if the solid content it too low, the final product texture will be too soft and difficult to dry, whereas if too high, it will not cover and bind properly to the cereal.

In yet an embodiment, the ratio (w/w) between rice flour and koji rice before fermentation is 1:10 to 10:1, such as in the range 1:10 to 1:5, such as in the range 1:10 to 1:1, such as in the range 1:1 to 10:1, or such as in the range 3:1 to 1:3.

In an embodiment, the step of applying may further comprise the addition of one or more oils, such as in the range 0-10% by weight, such as 1-10% by weight of the total weight of oil+cereal+fermented slurry of rice flour. In an embodiment, the oil is selected from the group consisting of sunflower oil, canola oil, coconut oil, and palm oil. Preferably, the oil is added via a different pump than the fermented slurry into the mixer. Thus, in another preferred embodiment, the step of applying includes a mixing step.

In another embodiment, the provided cereal product further comprises flake grains e.g. oat, dry fruit pieces, nuts, seeds, and/or cocoa powder.

Cereal Product Obtained by a Process

The cereal product obtainable by the process according to the invention, have some special organoleptic properties, especially in relation to sweetness and “stickiness”. Thus, an additional aspect of the invention relates to a cereal product obtained by a process according to the invention.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

Aim of Study

To develop a process for preparing a concentrated fermented cereal slurry made from rice koji (Amazake).

Materials and Methods

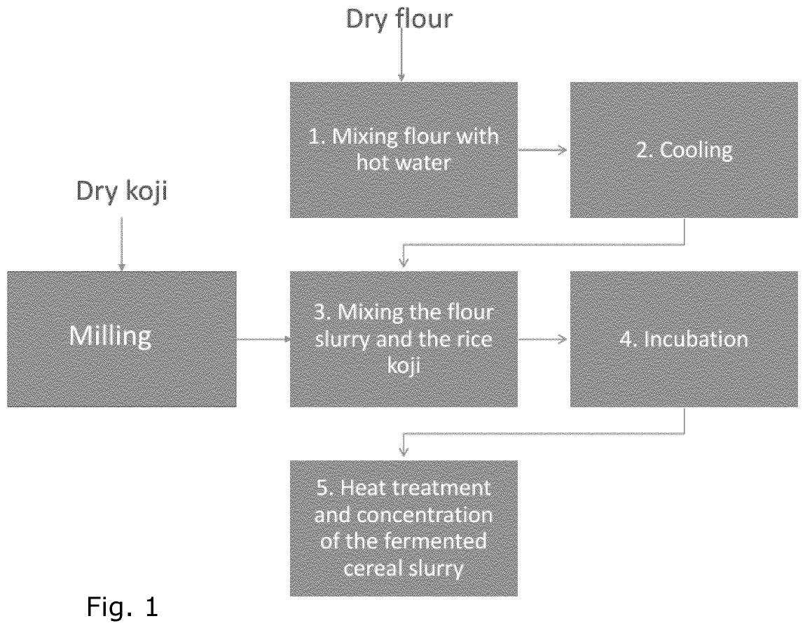

FIG. 1 outlines a process for preparing a concentrated fermented cereal slurry made from rice koji (Amazake).

Dry koji can be manufactured from rice, as refined grain.

Rice Koji is manufactured by adding Aspergillus Oryzae onto polished rice through solid state fermentation.

Rice koji is purchased from (Horaiya Honten Co., LTD.)

Flour can be a refined flour or whole grain flour. Flour can be sourced from wheat, rice, oat, barley, and rye but preferably from rice. Polished rice is preferred over whole grain rice as it is more neutral in taste.

Step 1: Flour paste is preferably in the range of 20-25% total solids. Hot water at a temperature between 90° and 98° C. is added into the vessel.

Step 2: The flour paste is cooled down to 60° C.

Step 3: proportion: 50% dry rice koji+50% dry flour/moisture content: 55-65%, preferably at 60% Cooked flour paste.

Step 4: incubation at 60° C. from 12 hours to 24 hours—level of sugar ((mono and disaccharides, mainly glucose) after 24 hr incubation is 50-80% on a dry basis.

Step 5: time & temperature: 100° C. 10 minutes. Concentration up to 50% total solids, such as 60% total solids, or such as 70% total solids.

Concentrating may be performed by heating in shallow cooking vessel and/or by a vacuum evaporator.

Conclusion

A process for preparing a concentrated fermented cereal slurry made from (rice) koji (Amazake) has been developed.

### Example 2

Aim of Study

To develop a process for preparing granolas made with the concentrated fermented cereal slurry made from rice koji (Amazake) (example 1).

Materials and Methods

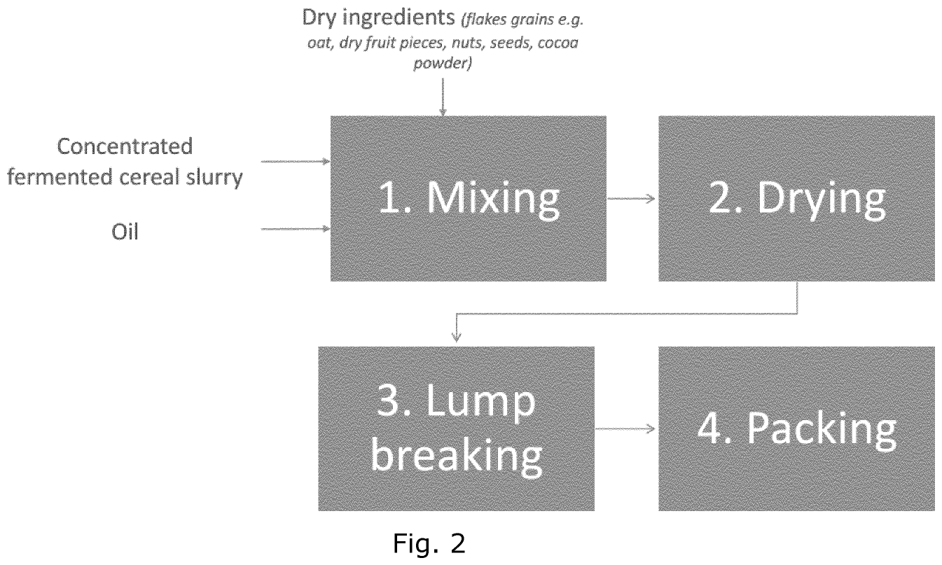

FIG. 2 outlines a process for preparing granolas made with the concentrated fermented cereal slurry made from rice koji (Amazake).

Step 1: ratio (w/w) oil/slurry (see example 1)/dry mix: 0-10/20-50/40-80. Examples of oil are but not limited to: Sunflower oil, canola oil, coconut oil, palm oil.

The dry mix may comprise flake grains e.g. oat, dry fruit pieces, nuts, seeds, and/or cocoa powder.

Step 2: target moisture 2-5%.

Step 3: lump breaking to generate clusters.

Step 4: packaging in individual pouch/multi-portion pouch.

Conclusion

A process for preparing granolas made with the concentrated fermented cereal slurry made from rice koji (Amazake) has been developed.

### Example 3

Aim of Study

To develop process for preparing “ready to eat” cereals coated with the concentrated fermented cereal slurry made from rice koji (Amazake).

Materials and Methods

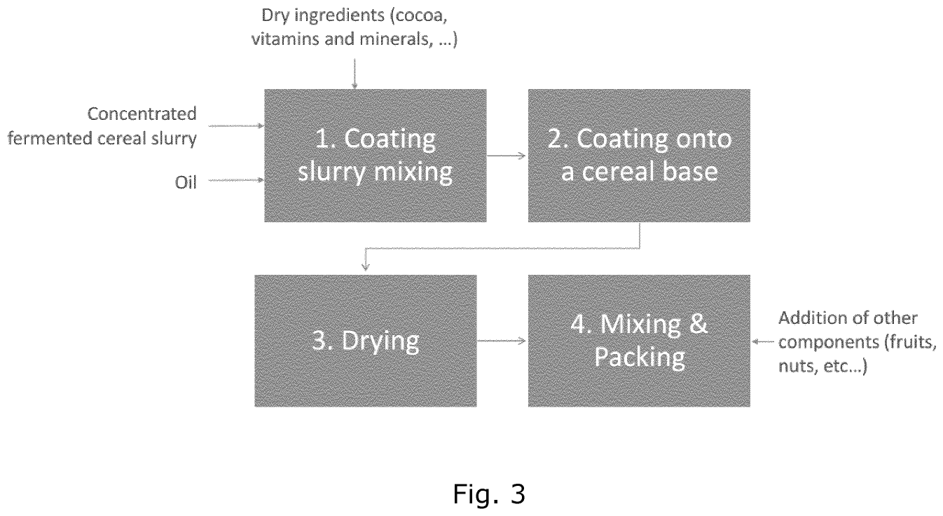

FIG. 3 outlines a process for preparing “ready to eat” cereals coated with the concentrated fermented cereal slurry made from rice koji (Amazake).

Step 1: Concentrated fermented cereal slurry: total solids from 50% to 70% (w/w)

Step 2: Coating slurry/cereal base ratio (w/w) 10/90 up to 50/50.

### Example 4

Aim of Study

To develop a process for preparing muesli coated with the concentrated fermented cereal slurry made from rice koji (Amazake).

Materials and Methods

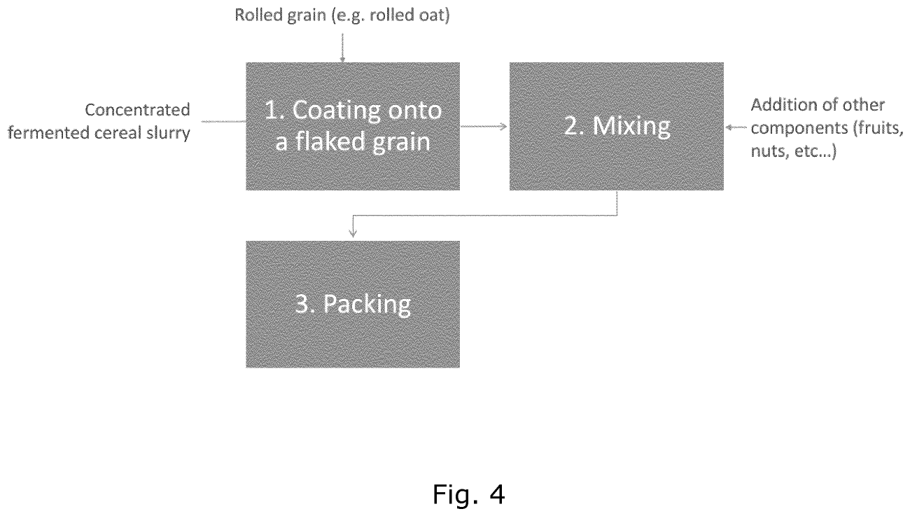

FIG. 4 outlines a process for preparing muesli coated with the concentrated fermented cereal slurry made from rice koji (Amazake).

Step 1: Coating slurry/Flake ratio 10/90 up to 25/75 (w/w).

### Example 5

Aim of Study

To identify the optimal flour to be used.

Materials and Methods

The following flours were tested:
polished rice,
brown rice (whole grain rice),
whole grain oat,
whole grain wheat,
whole grain barley, and
whole grain rye.

The different types of flours were fermented as outlined below:
Step 1: mixing of flour and water 90-98° C./20-25% total solids
Step 2: cooling down to 60° C.-70° C.
Step 3: adding the same level of dry rice koji as rice flour/coarsely milled rice—The moisture is at 55-65% moisture content before incubation.
Step 4: incubation at 60° C. from 8 hours to 24 hours—level of sugar (mono and disaccharides, mainly glucose) after 24 hour incubation is 50-60% on a dry basis.
Step 5: concentration up to 50% total solids even 60% total solids, even 70% total solids.

Results:

Taste:

White rice gave cleanest taste with no bitterness; it was followed by wholegrain rice then wholegrain rye then wholegrain wheat then wholegrain barley then wholegrain oat (most bitter).

Thus, white rice gave the best taste experience.

Clustering (Binding):

Granola made with natural sugars from date paste and banana purée: Bad clustering—16% total sugar (incl. the sugar from fruits)

Granola made with naturally sweetened fermented polished rice slurry: Good clustering.

Conclusion

Fermentation of rice flour shows superior organoleptic properties compared to the other tested flours.

### Example 6

Example of Granola Recipes:

| | | Recipe with |
|---|---|---|
| | Standard recipe to | fermented cereal to |
| | produce 100 g of | produce 100 g of |
| | finished product | finished product |
| Whole Oat flakes | 48 g | 48 g |
| Cereal crispies | 17 g | 17 g |
| Oil | 9 g | 9 g |
| Sugar | 16 g | 0 g |
| Oat flour | 4 g | 4 g |
| Glucose syrup | 6 g | 0 g |
| Fermented syrup (60% TS) | 0 g | 34 g |
| Honey | 2 g | 2 g |
| Sugar content | 22 g | 18 g |

Compared to the standard recipe the sensory results showed the same clustering strength, slightly milder sweetness due to the lower sugar content, the granola with fermented slurry is darker due to the higher level of reducing sugars.

1. A cereal product, comprising fermented rice flour, wherein the fermented rice flour has been fermented by koji rice.

2. The cereal product according to claim 1, wherein the fermented rice is milled rice.

3. The cereal product according to claim 1, wherein the fermented rice flour is in the form of a coating on the cereals or in the form of a binding agent, for binding/clustering of granola or cereal bars.

4. The cereal product according to claim 1, wherein the rice flour is selected from the group consisting of polished rice and/or brown rice.

5. The cereal product according to claim 1, wherein the cereal product comprises less than 0.01% (w/w) high intensive sweeteners and wherein the cereal product comprises less than 10% (w/w) refined sugar.

6. The cereal product according to claim 1, wherein the cereal product is selected from the group consisting of granolas, cereal bars and mueslis.

7. The cereal product according to claim 1, wherein the fermented rice flour constitutes in the range 5-50% by weight of the cereal product.

8. A food ingredient comprising a cereal product comprising fermented rice flour, wherein the fermented rice flour has been fermented by koji rice.

9-11. (canceled)

12. A process for preparing a cereal product, the process comprising:
providing a cereal product;
providing a fermented slurry of rice flour, wherein the fermented rice flour has bee fermented by koji rice; and
applying the fermented slurry of rice flour to the cereal product.

13. The process according to claim 12, wherein the fermented slurry of rice flour is applied to the cereal product as a coating or as clustering agent, such as for clustering the cereal product into granola.

14. The process according to claim 12, wherein the slurry of rice flour has a total solid content in the range 30-70%.

15. (canceled)
